(19) United States
(12) Patent Application Publication
(10) Pub. No.: US 2025/0270116 A1
(43) Pub. Date: Aug. 28, 2025

(54) PERMEATE CONDUIT SEGMENT FOR REVERSE OSMOSIS PROCESS ANDFLEXIBLE CONDUIT SEGMENT FOR WATER TREATMENT FACILITY

(71) Applicant: H2O INNOVATION INC., Québec (CA)

(72) Inventor: David JIMENEZ MADURGA, Bilbao (ES)

(21) Appl. No.: 18/705,000

(22) PCT Filed: Oct. 27, 2022
(86) PCT No.: PCT/CA2022/051594

§ 371 Date: Apr. 26, 2024

Related U.S. Application Data
(60) Provisional application No. 63/273,297, filed on Oct. 29, 2021.

(51) Int. Cl. C02F 1/44; B01D 61/02; B01D 61/10; B01D 65/10

(52) U.S. Cl. CPC C02F 1/441; B01D 61/025; B01D 61/10; B01D 65/102; B01D 2313/125; B01D 2313/13; B01D 2313/2011; B01D 2313/903; C02F 2201/004

(57) ABSTRACT

A reverse osmosis system forming part of a reverse osmosis stage of a desalination water treatment plant, the reverse osmosis system has: a reverse osmosis unit having a reverse osmosis membrane housed in a pressure vessel extending longitudinally along an axis, and having a port extending along the axis: a conduit; and a permeate outlet segment connecting the port to the conduit, the permeate outlet segment having: a first connecting end hydraulically connected to the port of the reverse osmosis unit; a second connecting end hydraulically connected to the conduit; an elbow between the first connecting end and the second connecting end; and an inspection port stemming from the elbow, the inspection port being aligned with the first connecting end along the axis.

### CROSS-REFERENCE TO RELATED APPLICATIONS

This application claims benefit from U.S. provisional application No. 63/273,297 filed on Oct. 29, 2021.

### BACKGROUND

Water treatment facilities are key civil infrastructures in many countries around the world, and are used to transform a source of water into potable water. Depending on the water source, different technologies can be used, and many water treatment facilities use a number of filtration stages which use different technologies. Desalination plants, for instance, use salt water from an ocean or sea as the water source. Such plants include a plurality of filtration stages, and typically include, in sequence, a screening stage to prevent introduction of marine life or other larger objects into the plant, a pre-filtration stage, a cartridge filtration stage, and typically more than one reverse osmosis stage along the main water treatment line. The details can vary significantly from one application to another. While many existing technologies were satisfactory to a certain degree, there always remains room for improvement.

### SUMMARY

In accordance with one aspect, in some water treatment stage applications, using flexible conduits to connect different segments of the main water treatment line can be advantageous. However, each connection between distinct segments represents both installation time, which is associated to cost and subject to scarcity of qualified laborers, and a potential leakage point. There remained room for improvement either in terms of facilitating installation, reducing potential leakage points, or both.

In accordance with another aspect, a given reverse osmosis stage such as can be used in desalination plants, in particular, typically includes a plurality of reverse osmosis units operating in parallel. Each reverse osmosis unit includes a spiral wound membrane housed within a corresponding, elongated and cylindrical, pressure vessel. The spiral wound membrane separates a brine flow path from a permeate flow path. The pressure across the membrane can be in the order of 60+ Bar in some cases. The permeate flow path typically leads to a permeate outlet which extends axially relative to an axis of the pressure vessel, whereas the brine outlet typically extends transversally/radially. Monitoring and inspection of the reverse osmosis units can be required and thus need to be provided for in the final configuration. To this end, a T junction can be used at the permeate outlet. Permeate enters the T junction through the horizontal bar of the T junction and exits the T junction through the vertical bar, defining a 90° turn during normal operation. Monitoring and/or inspection can be performed via the other end of the horizontal bar of the T junction. Indeed, inspection may require introducing a tool such as a flexible hose into the reverse osmosis unit, and axial access to the center of the spiral wound membrane can be provided via the horizontal bar of the T junction. While such an arrangement can be satisfactory to a certain degree, there can remain room for improvement. In particular, the 90° turn can represent a significant source of pressure drop, increasing the amount of energy required to operate the desalination plant.

In one aspect, there is provided a reverse osmosis system forming part of a reverse osmosis stage of a desalination water treatment plant, the reverse osmosis system comprising: a reverse osmosis unit having a reverse osmosis membrane housed in a pressure vessel extending longitudinally along an axis, and having a port extending along the axis; a conduit; and a permeate outlet segment connecting the port to the conduit, the permeate outlet segment having: a first connecting end hydraulically connected to the port of the reverse osmosis unit; a second connecting end hydraulically connected to the conduit; an elbow between the first connecting end and the second connecting end; and an inspection port stemming from the elbow, the inspection port being aligned with the first connecting end along the axis.

The reverse osmosis system described above may include any of the following features, in any combinations.

In some embodiments, the inspection port is defined by an inspection section stemming from the elbow of the permeate outlet segment along a port axis, the port axis being coaxial with a central axis of the permeate outlet segment at the first connecting end.

In some embodiments, the permeate outlet segment has a straight section extending from the first connecting end to the elbow, the inspection port being coaxial with the straight section.

In some embodiments, the elbow defines a 90 degrees angle.

In some embodiments, a cross-sectional area of the inspection section is less than that of the elbow.

In some embodiments, the conduit defines a flow passage, a flow circulating area of the flow passage decreasing from a conduit inlet to a conduit outlet.

In some embodiments, the flow circulating area decreases along a transition section of the conduit, the transition section being free of a joint.

In some embodiments, the flow circulating area decreases long a frustoconical section of the conduit.

In some embodiments, the permeate outlet segment is a monolithic body defining the inspection port.

In another aspect, there is provided a permeate outlet segment used as an interface between a reverse osmosis unit and a conduit, comprising: an inlet; an outlet; an elbow between the inlet and the outlet; and an inspection port at the elbow, the inspection port being aligned with the inlet.

The permeate outlet segment described above may include any of the following features, in any combinations.

In some embodiments, the inspection port is defined by an inspection section stemming from the elbow of the permeate outlet segment along an axis, the axis being coaxial with a central axis of the permeate outlet segment at a first connecting end.

In some embodiments, a straight section extends from the first connecting end to the elbow, the inspection port being coaxial with the straight section.

In some embodiments, the elbow defines a 90 degrees angle.

In some embodiments, a cross-sectional area of the permeate outlet segment is less than that of the elbow.

In yet another aspect, there is provided a conduit for connecting a reverse osmosis unit to a source of water, comprising: an inlet; an outlet; a flow passage between the inlet and the outlet, the flow passage defining an upstream portion, a transition portion, and a downstream portion, a cross-sectional area of the flow passage being less at the downstream portion than at the upstream portion.

The conduit described above may include any of the following features, in any combinations.

In some embodiments, the transition portion of the flow passage has a frustoconical shape.

In some embodiments, the conduit is monolithic and free of joint along the transition portion.

In still another aspect, there is provided a water treatment facility, comprising: a filtration unit hydraulically connected to a source of water to be filtered, the filtration unit having a port to allow water to flow therethrough; and a flexible conduit in fluid flow communication with the port, the flexible conduit extending from an inlet to an outlet, the flexible conduit having: an inlet coupling, an outlet coupling, and a flow passage between the inlet coupling and the outlet coupling, the flow passage having a transition portion forming a change of flow circulating area between inlet coupling and the outlet coupling.

The water treatment facility described above may include any of the following features, in any combinations.

In some embodiments, the transition portion of the flow passage has a frustoconical shape.

In some embodiments, the flexible conduit is free of a joint along the transition portion.

Many further features and combinations thereof concerning the present improvements will appear to those skilled in the art following a reading of the instant disclosure.

### BRIEF DESCRIPTION OF THE DRAWINGS

FIG. 1A is an oblique view of a section of a water treatment facility in accordance with one embodiment;

FIG. 1B is a three-dimensional view of a reverse osmosis filtration system which may be used as part of the water treatment facility of FIG. 1A in accordance with one embodiment;

FIG. 1C is an oblique, partially transparent view of a reverse osmosis unit in accordance with one embodiment;

FIG. 2 is schematic three-dimensional view of a reverse osmosis unit connected to a network of conduits via a permeate outlet segment in accordance with one embodiment;

FIG. 3 is a cutaway view of the permeate outlet segment of FIG. 2;

FIG. 4 is a cutaway view of a flexible conduit segment shown connected to a permeate outlet segment, in accordance with another embodiment;

FIG. 5 is a plan view illustrating different connecting possibilities of permeate outlet segments in accordance with a plurality of alternative embodiments; and

FIG. 6 is a cutaway view of a coupling used to secured two conduits together in accordance with one embodiment.

### DETAILED DESCRIPTION

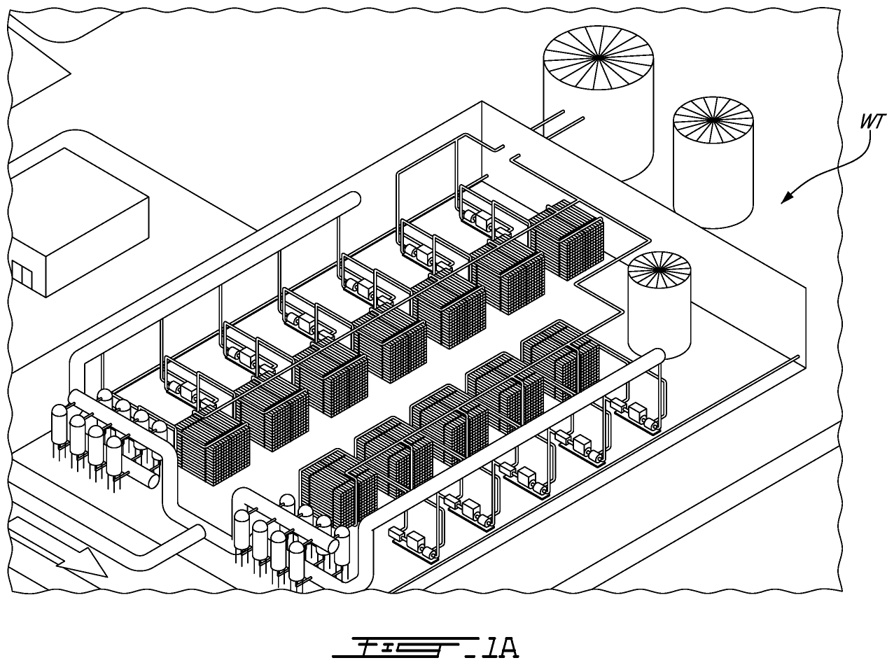

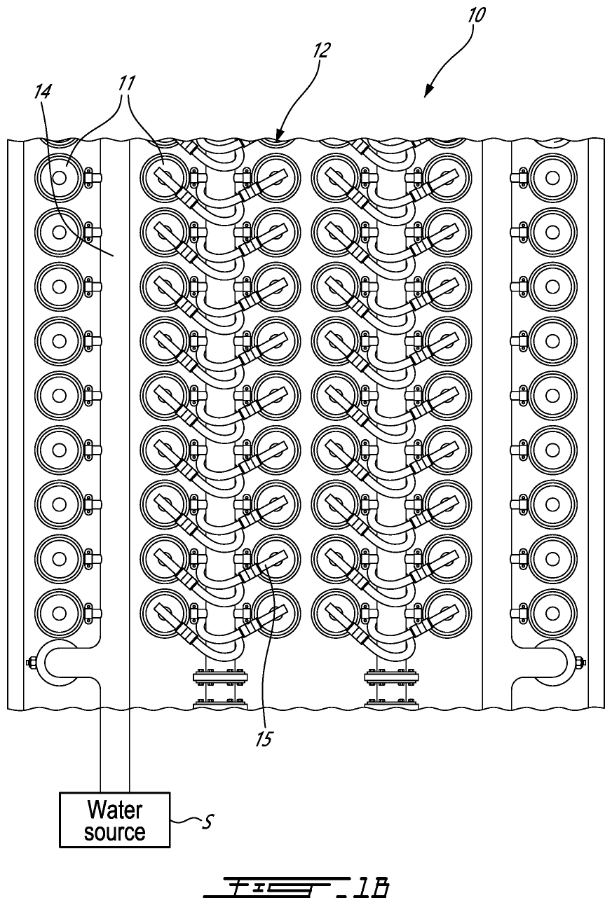

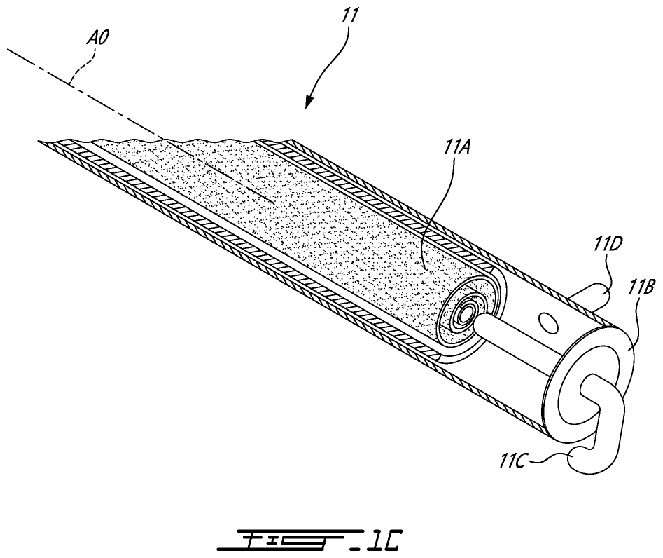

Referring to FIG. 1A, a portion of an example water treatment facility, and more specifically a desalination plant, is shown at WT. The portion includes a plurality of cartridge filtration systems forming a cartridge filtration stage, and a plurality of reverse osmosis filtration systems, forming a first and second reverse osmosis filtration stages. Pre-filtration is not shown.

Referring now to FIG. 1B, an example reverse osmosis filtration system is shown at 10. The water treatment facility 10 includes a plurality of reverse osmosis filtration units 11. As best seen in FIG. 1C, each reverse osmosis filtration unit 11 includes a spiral wound membrane 11A housed in a pressure vessel 11B. The pressure vessel 11B is cylindrical and elongated, and may be said to have an axis A0 associated to its cylindrical geometry. The membrane 11A is spiral wound roughly around the axis A0, and separates a permeate path from a brine path. A permeate outlet 11C extends axially from the end of the reverse osmosis filtration unit 11, whereas a brine outlet 11D extends radially and laterally. Returning to FIG. 1B, the permeate outlets 11C are fluidly connected to a network of conduits which may form a permeate line, ultimately leading to a potable water reservoir. The network of conduits 12 may include main conduits 14. Flexible conduit segments 15 may be used to connect the permeate outlets to the main conduits. The water treatment facility 10 is used to filter water from a water source S, coming from an earlier filtration stage, in particular, and referring to FIG. 1A, using a cartridge filtration stage is typical to protect the reverse osmosis membranes.

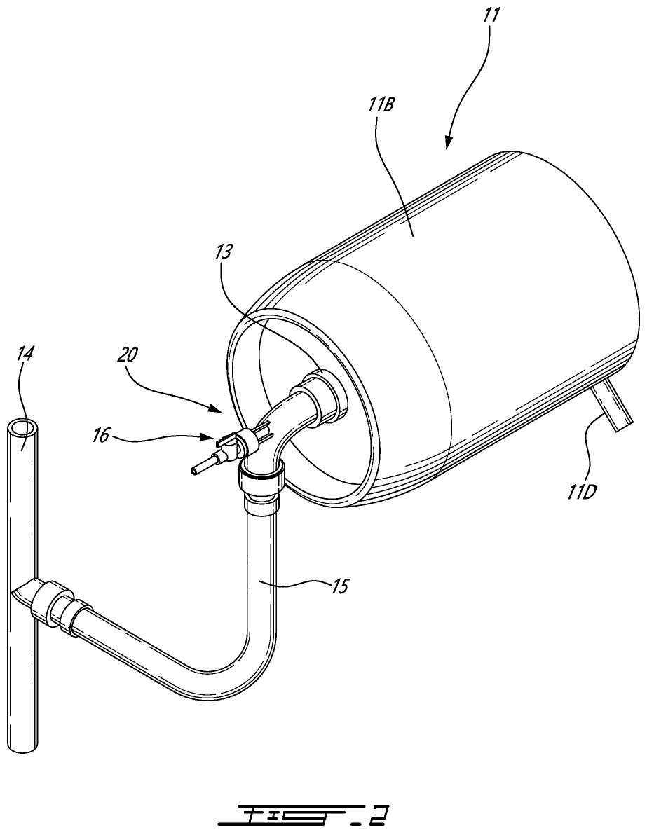

Referring now to FIG. 2, each of the vessels 11B of the units 11 includes a port 13 associated here to the permeate outlet 11C, to be hydraulically connected to the main conduit 14. In this embodiment, this is done via a sequence of two conduit segments: i) a rigid segment 20 and ii) a flexible conduit segment 15. In some embodiments, a somewhat similar arrangement may be used at an axial inlet to the reverse osmosis filtration unit. A permeate outlet segment 20 is used as an interface between the flexible conduit 15 and the port 13 of the vessel 11. The permeate outlet segment 20 is designed to allow inspection of the reverse osmosis unit 11 as will be discussed further below.

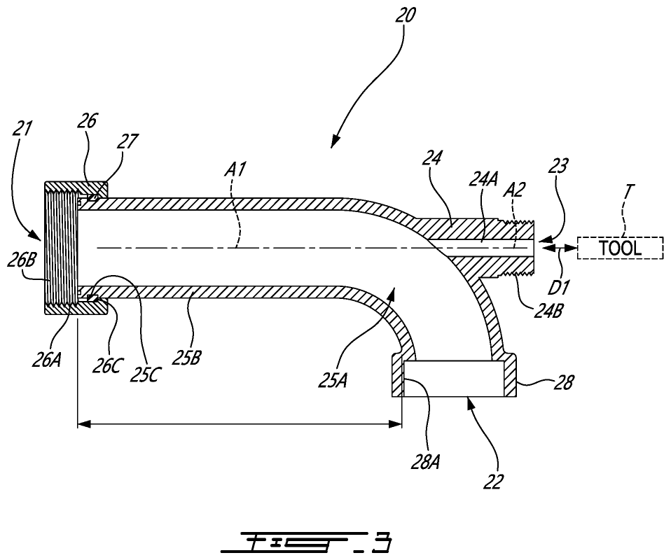

In an alternate embodiment, seen to a certain extent in FIG. 1B, permeate outlet segments may be formed of T-couplings. These T-couplings may first create a significant pressure drop since the water exiting a vessel 11B has to turn sharply by 90 degrees to reach the network of conduits 12. This inconvenience was tolerated due to the fact that the other horizontal end of the T was needed to provide axial access into the reverse osmosis unit for inspection, and could also be used to secure a sensor for monitoring the operation, for instance. The permeate outlet segment 20 shown in FIGS. 2 and 3 may at least partially alleviate this drawback.

Referring now to FIG. 3, the permeate outlet segment 20 is shown in greater detail and may at least partially alleviate these drawbacks. The permeate outlet segment 20 has an inlet 21 that is hydraulically connected to the port 13 of the vessel 11. The permeate outlet segment 20 further has an outlet 22. The permeate outlet segment 20 includes an inspection port 23, that is sized to allow insertion of an inspection tool to inspect the unit 11. The permeate outlet segment 20 defines an elbow section 25A between the inlet 21 and the outlet 22. The elbow section 25A allows to change the direction of the flow of the water flowing from the inlet 21 to the outlet 22 with significantly less pressure loss than a T-segment would. Moreover, the inspection port 23 may have a diameter significantly smaller, such as less than half, less than a quarter, and even less than a fifth of the diameter of the elbow section 25A, which may further reduce any turbulence associated to its presence, and thus the associated pressure drop. The elbow section 25A may define an angle of about 90 degrees, but it will be appreciated that any other suitable angle may be used. The elbow section 25A may provide a smooth turning of the flow of water from the inlet 21 to the outlet 22 thereby minimizing pressure drops across the permeate outlet segment 20.

The permeate outlet segment 20 includes a straight section 25B extending from the inlet 21 to the elbow section 25A. The straight section 25B extends along an axis A1. The inspection port 23 is defined by an inspection section 24 that is aligned the axis A1. In other words, a passage area 24A defined by the inspection section 24 is substantially aligned with the axis A1 of the straight section 25B. In the embodiment shown, the inspection section 24 stems from the elbow section 25A. Therefore, a central axis A2 of the inspection section 24 may be coaxial with the axis A1 of the straight section 25B of the permeate outlet segment 20. In other words, the inspection port 23 may be coaxial with the straight section 25B. A line of sight may be created between the inspection section 24 and the port 13 of the unit 11.

The inspection section 24 may define outer threads 24B via which may be fastened to an inspection valve 16 (FIG. 2). Other suitable connection means may be used. The inspection valve 16 has a closed configuration in which the inspection port 23 is sealed thereby preventing water from leaking out of the permeate outlet segment 20. The inspection valve 16 (FIG. 2) has an open configuration in which access to the vessel 11 via the inspection section 24 and via the straight section 25B of the permeate outlet segment 20 is permitted.

As shown in FIG. 3, an inspection device or tool T may be inserted inside the inspection section 24 along direction D1. The inspection tool T may therefore be moved along the direction D1, which is parallel to the axis A1 of the straight section 25B, inside the passage area 24A of the inspection section 24 of the permeate outlet segment 20 and inside the straight section 25B until it reaches the inlet 21 and then the port 13 of the vessel 11B via which the tool T may enter the vessel 11B of the unit 11 for inspection. The tool T may be, for instance, a probe, a camera, and so on.

Having the inspection port 23 coaxial, or substantially coaxial, with the inlet 21 may allow an inspection tool to easily reach the inside of the vessel 11 without having to disconnect the vessel 11. Herein, the expression “substantially coaxial” is meant to encompass slight variations that may be the result of manufacturing tolerances and so on. A radial distance between the two axes A1, A2 is permitted so long as the tool T may be inserted in to the unit 11 via the inspection port 24. The two axes A1, A2 may be parallel to one another, although a slight angle therebetween is contemplated as the result of manufacturing tolerances and so on. A maintenance technician may simply open the inspection valve 16 and insert the tool T along a direction parallel to the axes A1 and A2 to reach the inlet 21 and thereby reaching the inside of the vessel 11. Efficient efficiency gains may therefore be achieved with the disclosed permeate outlet segment 20.

Still referring to FIG. 3, in this specific embodiment, the permeate outlet segment 20 includes an inlet connecting section 26 at the inlet 21. The inlet connecting section 26 includes a coupling nut 26A that is rotatable relative to the axis A1 of the straight section 25B. A retaining ring 27 may be disposed radially between the straight section 25B and the coupling nut 26A to axially lock the coupling nut 26A to the straight section 25B of the permeate outlet segment 20. The retaining ring 27 may be received within an annular groove 25C defined by the straight section 25B of the permeate outlet segment 20 proximate the inlet 21. The coupling nut 26A may define inner threads 26B to engage corresponding threads defined by the port 13 of the vessel 11 or to engage an adaptor as will be discussed below. In some configurations, the coupling nut 26A defines outer threads. Any suitable connection means are contemplated. The coupling nut 26A may define a shoulder 26C against which the retaining ring 27 is in abutment to axially lock the coupling nut 26A to the straight section 25B of the permeate outlet segment 20.

The permeate outlet segment 20 defines an outlet connecting section 28 at an end of the elbow section 25A. The outlet connecting section 28 herein corresponds to a coupler end 28A having a greater diameter than a diameter of the elbow section 25A. The coupler end 28A is sized to be engaged by a suitably shaped end of the flexible conduit 15. It would be appreciated that any suitable couplings may be defined at the inlet and at the outlet of the permeate outlet segment 20. Any suitable connection means may be provided at the outlet connecting section 28.

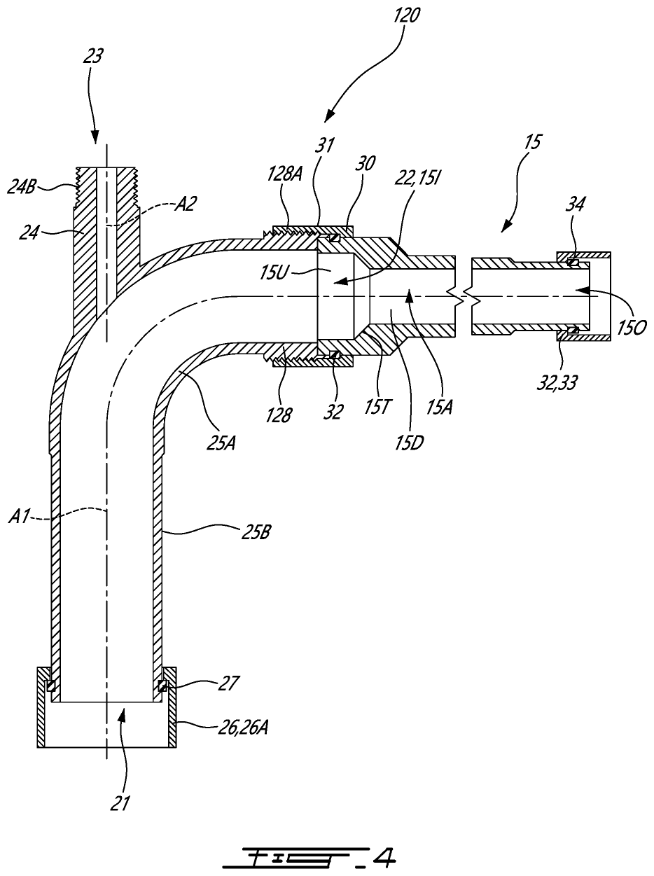

Referring now to FIG. 4, another embodiment of a permeate outlet segment is shown that 120. For the sake of conciseness, only the elements that differ from the permeate outlet segment 20 described above with reference to FIG. 3 are described herein below.

In the embodiment shown, the permeate outlet segment 120 as a connecting section 128 at the outlet 22. The connecting section 128 defines outer threads 128A. The outer threads 128A are threadingly engageable to a connecting section 30 of the flexible conduit 15. The connecting section 30 includes a coupling nut 31 that is rotatable relative to a remainder of the flexible conduit 15 and a retaining ring 32 is used to lock the coupling nut 31 to the flexible conduit 15. The coupling nut 31 is similar to the coupling nut 26A described above. As previously explained, the retaining ring 32 is received within an annular groove defined by the flexible conduit 15. A second connecting section may be located at the opposed end of the flexible conduit 15. The second connecting section includes a second coupling nut 33 rotatable relative to a body of the flexible conduit 15. A similar retaining ring 34 is used to axially lock the second coupling nut 33 to the flexible conduit 15.

In some cases, adaptors have to be used for interconnecting two conduits having different diameters. However, such adaptors increase a number of connections that have to be watertight, thereby increasing a risk of leakage. The flexible conduit 15 defines a flow passage 15A between an inlet 151 and an outlet 150. The flow passage 15A defines an upstream portion 15U, a transition portion 15T, and a downstream portion 15D. A cross-sectional area of the flow passage 15A being less at the downstream portion 15D than at the upstream portion 15U. In the embodiment shown, the transition portion 15T has a frustoconical shape. The flexible conduit 15 may be monolithic and free of joint through the upstream, transition, and downstream portions 15U, 15T, 15D. This may reduce risks of leakage. Any suitable shape for the transition portion 15T is contemplated. The transition portion 15T may merge tangentially to both of the upstream and downstream portions 15U, 15D.

Adding the flexible conduit 15 defining this decrease in diameter may avoid the need from using another coupler that would create an interface between the permeate outlet segment 120 and another conduit. Consequently, a number of connections may be limited. This may limit potential leak locations. Therefore, leak risks may be reduced with the disclosed flexible conduit 15. Moreover, this transition portion 15T may further help in maintaining pressure drops as low as possible compared to a configuration using an adaptor to bridge two conduits of different diameters as it may offer a smooth transition between the upstream and downstream portion 15U, 15D.

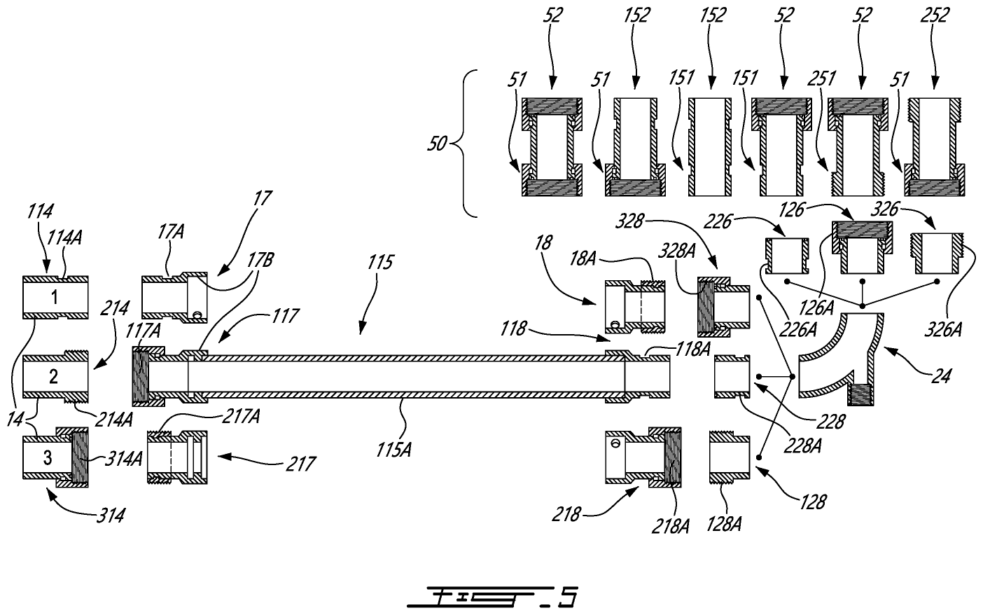

Referring now to FIG. 5, a plurality of possible connecting sections of the different parts of the network of conduits 12 are illustrated and described herein below.

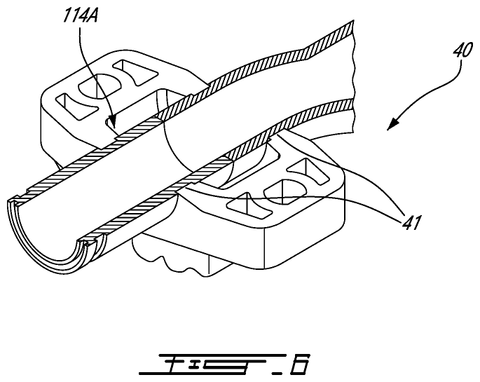

As illustrated, the main conduits 14 may be hydraulically connected to the flexible conduits 15 using any suitable connections. For instance, a grooved connecting end 114 may be provided. As shown in FIG. 6, such a grooved connecting end 114 defines a groove 114A that extends annularly around the main conduit 14 and that is sized to accept an annular protrusion defined by a coupling 40. Such a coupling 40 typically includes two sections each defining about half of the annular protrusion; the two sections being securable to one another around portions of two conduits to be connected together. The coupling 40 includes two annular protrusions 41 each receivable within a respective groove defined by the conduits to axially lock the conduits together and provide a watertight connection.

In accordance with another embodiment, the connecting section at the end of the main conduit 14 may be defined by a threaded male connection 214. Such a threaded male connection 214 defines outer threads 214A threateningly engageable by a threaded female connection. In another embodiment, the connecting section at the end of the main conduit 14 may include a coupling nut 314 defining inner threads 314A. Such a coupling nut 314 is described hereinabove with reference to FIGS. 3-4.

Still referring to FIG. 5, a first end of the flexible conduit 15 may be hydraulically connected to the main conduit 14 using a plurality of possible embodiments of connecting sections. For instance, the connecting section at the first end of the flexible conduit may include a grooved connecting end 17 defining an annular groove 17A similar to the grooved connecting end described hereinabove. Alternatively, the connecting section at the first end of the flexible conduit 15 may include a coupling nut 117 defining inner threads 117A. In another embodiment, the connecting section at the first and the flexible conduit 15 may include a threaded male connection 217 defining outer threads 217A.

A second end of the flexible conduit 15 may be hydraulically connected to the permeate outlet segment 20 using a plurality of possible embodiments of connecting sections. For instance, the connecting section at the second end of the flexible conduit 15 may include a grooved connecting end 118 defining an annular groove 118A similar to the grooved connecting end described hereinabove. Alternatively, the connecting section at the second end of the flexible conduit 15 may include a coupling nut 218 defining inner threads 218A. In another embodiment, the connecting section at the second end the flexible conduit 15 may include a threaded male connection 18 defining outer threads 18A.

In the embodiment shown, the flexible conduit 115 include a central body 115A and the different connecting sections may be secured at opposed ends of the central body 115A. As illustrated, each of the connecting sections 17, 117, 217, 18, 118, 218 defined a conduit-receiving end 17B (only one identified for clarity). The opposed ends of the central body 115A may be slidingly engaged into the conduit-receiving ends 17B. The central body 115A may be permanently secured to the different connecting sections 17, 117, 217, 18, 118, 218 via the conduit-receiving ends 17B via gluing, welding, brazing, or any other suitable fastening means.

Similarly, the inlet connecting section of the permeate outlet segment 20 may include the coupling nut 126 as described hereinabove and defining inner threads 126A, a grooved connecting end 226 having an annular groove 226A, or threaded male connection 326 defining outer threads 326A. The same three possible kind of connections may be provided at the outlet connecting section 28 of the permeate outlet segment 20. In other words, either one of a grooved connecting end 228 defining an annular groove 228A, a coupling nut 328 defining inner threads 328A, or a threaded male connection 128 defining outer threads 128A may be provided.

The permeate outlet segment 20 may be hydraulically connected to the reverse osmosis unit 11 via any suitable adapter 50. A plurality of possible embodiments of adapters are shown. In the first embodiment, the adapter may include a coupling nut 51 at an inlet thereof and another coupling nut 52 at an outlet thereof. In a second embodiment, a coupling nut 51 is provided at an inlet of the adapter and a grooved connecting end 152 is provided at the outlet of the adapter. In third embodiment, both of the inlet and the outlet of the adapter are provided with grooved connecting ends 151, 152. In a fourth embodiment, a grooved connecting end 151 is provided at an inlet thereof and a coupling nut 52 at an outlet thereof. In a fifth embodiment, the adapter is provided with a male threaded connection 251 at an inlet thereof and with the coupling nut 52 at an outlet thereof. In a sixth embodiment, the permeate outlet segment is provided with a coupling nut 51 at an inlet thereof and with the male threaded connection 252 at an outlet thereof. It will be appreciated that a person skilled in the art may select the appropriate connecting end.

As can be seen therefore, the examples described above and illustrated are intended to be exemplary only. For instance, the flexible conduit can be used in a reverse osmosis stage or in a ultra filtration stage. The scope is indicated by the appended claims.

1. A reverse osmosis system forming part of a reverse osmosis stage of a desalination water treatment plant, the reverse osmosis system comprising:
a reverse osmosis unit having a reverse osmosis membrane housed in a pressure vessel extending longitudinally along an axis, and having a port extending along the axis;
a conduit; and
a permeate outlet segment connecting the port to the conduit, the permeate outlet segment having:
a first connecting end hydraulically connected to the port of the reverse osmosis unit;
a second connecting end hydraulically connected to the conduit;
an elbow between the first connecting end and the second connecting end; and
an inspection port stemming from the elbow, the inspection port being aligned with the first connecting end along the axis.

2. The reverse osmosis system of claim 1, wherein the inspection port is defined by an inspection section stemming from the elbow of the permeate outlet segment along a port axis, the port axis being coaxial with a central axis of the permeate outlet segment at the first connecting end.

3. The reverse osmosis system of claim 1, wherein the permeate outlet segment has a straight section extending from the first connecting end to the elbow, the inspection port being coaxial with the straight section.

4. The reverse osmosis system of claim 1, wherein the elbow defines a 90 degrees angle.

5. The reverse osmosis system of claim 2, wherein a cross-sectional area of the inspection section is less than that of the elbow.

6. The reverse osmosis system of claim 1, wherein the conduit defines a flow passage, a flow circulating area of the flow passage decreasing from a conduit inlet to a conduit outlet.

7. The reverse osmosis system of claim 6, wherein the flow circulating area decreases along a transition section of the conduit, the transition section being free of a joint.

8. The reverse osmosis system of claim 6, wherein the flow circulating area decreases long a frustoconical section of the conduit.

9. The reverse osmosis system of claim 1, wherein the permeate outlet segment is a monolithic body defining the inspection port.

10. A permeate outlet segment used as an interface between a reverse osmosis unit and a conduit, comprising:
an inlet;
an outlet;
an elbow between the inlet and the outlet; and
an inspection port at the elbow, the inspection port being aligned with the inlet.

11. The permeate outlet segment of claim 10, wherein the inspection port is defined by an inspection section stemming from the elbow of the permeate outlet segment along an axis, the axis being coaxial with a central axis of the permeate outlet segment at a first connecting end.

12. The permeate outlet segment of claim 10, a straight section extending from the first connecting end to the elbow, the inspection port being coaxial with the straight section.

13. The permeate outlet segment of claim 10, wherein the elbow defines a 90 degrees angle.

14. The permeate outlet segment of claim 13, wherein a cross-sectional area of the permeate outlet segment is less than that of the elbow.

15. (canceled)

16. (canceled)

17. (canceled)

18. A water treatment facility, comprising:
a filtration unit hydraulically connected to a source of water to be filtered, the filtration unit having a port to allow water to flow therethrough; and
a flexible conduit in fluid flow communication with the port, the flexible conduit extending from an inlet to an outlet, the flexible conduit having:
an inlet coupling,
an outlet coupling, and
a flow passage between the inlet coupling and the outlet coupling, the flow passage having a transition portion forming a change of flow circulating area between inlet coupling and the outlet coupling.

19. The water treatment facility of claim 18, wherein the transition portion of the flow passage has a frustoconical shape.

20. The water treatment facility of claim 18, wherein the flexible conduit is free of a joint along the transition portion.
